(19) United States
(12) Patent Application Publication
(10) Pub. No.: US 2016/0139281 A1
(43) Pub. Date: May 19, 2016

(54) Method for increasing detection sensitivity of radon monitor based on electrostatic collection method and device thereof

(71) Applicant: HENGYANG NORMAL UNIVERSITY, Hengyang, Hunan (CN)

(72) Inventors: Yanliang Tan, Hengyang,Hunan (CN); Hongzhi Yuan, Hengyang,Hunan (CN)

(21) Appl. No.: 14/783,845

(22) PCT Filed: Jan. 27, 2015
(86) PCT No.: PCT/CN2015/071614

§ 371 Date: Oct. 9, 2015

(30) Foreign Application Priority Data
May 20, 2014 (CN) 201410212703.0

(51) Int. Cl. G01T 7/06; G01T 1/24; G01T 1/167

(52) U.S. Cl. CPC G01T 7/06; G01T 1/167; G01T 1/24

(57) ABSTRACT

A method for increasing a detection sensitivity of a radon monitor based on an electrostatic collection method and a device thereof increase the detection sensitivity of the radon monitor based on the electrostatic collection method through increasing a collection efficiency of positively charged ²¹⁸Po in an internal cell of the radon monitor based on the electrostatic collection method. A metal mesh is provided between a wall of the internal cell and a semiconductor detector to increase an electric field intensity close to the wall of the internal cell. A ground wire of a high-voltage module is connected to a surface of the semiconductor detector. High-voltage outputting wires of the high-voltage module are respectively connected to the wall of the internal cell and the metal mesh, in such a manner that high voltages are respectively outputted between the wall of the internal cell and the metal mesh and between the metal mesh and the surface of the semiconductor detector. Because the electric field intensity close to the wall of the internal cell is increased through directly increasing the voltage between the wall of the internal cell and the metal mesh, once the voltages between the wall of the internal cell and the metal mesh and between the metal mesh and the surface of the semiconductor detector are adjusted to appropriate values, a collection efficiency of an electrostatic field to the positively charged ²¹⁸Po is increased.

### CROSS REFERENCE OF RELATED APPLICATION

This is a U.S. National Stage under 35 U.S.C 371 of the International Application PCT/CN2015/071614, filed Jan. 27, 2015, which claims priority under 35 U.S.C. 119(a-d) to CN 201410212703.0, filed May 20, 2014.

### BACKGROUND OF THE PRESENT INVENTION

1. Field of Invention

The present invention relates to a nuclear radiation detection technology, and more particularly to a method for increasing a detection sensitivity of a radon monitor based on an electrostatic collection method through increasing a collection efficiency of positively charged ²¹⁸Po in an internal cell of the radon monitor based on the electrostatic collection method, and a device thereof.

2. Description of Related Arts

The radon (²²²Rn) in the environment is the main source of the natural radiation which human suffers from. Multiple radon measuring methods and devices are available based on the different measurement principles. The radon monitor based on the electrostatic collection method is widely applied because of the high automation degree and the energy spectrum resolving capability which is able to eliminate the interference of the ²²⁰Rn. The electrostatic collection method comprises steps of: providing the internal cell which is generally hemispheric or cylindrical; providing the semiconductor detector on the upper part of the internal cell; and outputting the high voltage between the wall of the internal cell and the semiconductor detector to form the electrostatic field. After filtering off the progeny of the radon, the radon is pumped into the internal cell with the air in the environment and continues decaying in the internal cell to generate the positively charged ²¹⁸Po. The positively charged ²¹⁸Po is collected to the surface of the semiconductor detector under the effect of the electrostatic field. During the collection, the positively charged ²¹⁸Po collides with the molecules and the ions in the air. If the positively charged ²¹⁸Po collides with the negatively charged OH— ions, it is possible to become a neutralization particle for recombination which is unable to be collected to the surface of the semiconductor detector by the electrostatic field, decreasing the collection efficiency. The conventional theoretical simulations and experiments indicate that: the electric field intensity close to the surface of semiconductor detector of the internal cell is large, and the electric field intensity close to the inner surface of the internal cell is relatively small. Thus, the positively charged ²¹⁸Po generated through the radon decay, close to the inner surface of the internal cell, has the low drift velocity and the long collection time under the effect of the electrostatic field. Moreover, during the collection, it is highly probable for the positively charged ²¹⁸Po to recombine with the negatively charged OH— ions, which leads to the low collection efficiency of the positively charged ²¹⁸Po being collected to the surface of the semiconductor detector by the electrostatic field and accordingly the decrease of the detection sensitivity of the radon monitor.

The conventional measuring device based on the electrostatic collection method, as showed in FIG. 4, comprises the internal cell 1, the inlet pipe 2, the outlet pipe 3, the pump 4, the high-voltage module 5 and the semiconductor detector 6, wherein:

the inlet pipe 2 and the outlet pipe 3 are respectively provided on the wall of the internal cell 1 and intercommunicated with the cavity of the internal cell 1;

the pump 4 is provided on the outlet pipe 3 or the inlet pipe 2; and

the semiconductor detector 6 is provided on the insulating plate at the top part of the internal cell 1.

The wall of the internal cell 1 is the electrically-conductive metal wall and the top part of the internal cell is the insulating plate. The high voltage is directly outputted on the metal wall of the internal cell 1 and the surface of the semiconductor detector 6. Thus, the electric field intensity close to the wall of the internal cell 1 is low; the positively charged ²¹⁸Po generated through the radon decay, close to the wall of the internal cell 1, has the low drift velocity in the electric field; the long collection time increases the recombination probability of the positively charged ²¹⁸Po with the negatively charged OH— ions in the internal cell 1; and the collection efficiency of the positively charged ²¹⁸Po being collected to the surface of the semiconductor detector 6 is low. Because of the structural features of the internal cell 1, even if increasing the voltage, the growth rate of the electric field intensity close to the wall of the internal cell is greatly lower than the growth rate of the voltage. Thus, when the voltage is increased to a threshold value, the collection efficiency will not increase with the voltage any more.

### SUMMARY OF THE PRESENT INVENTION

An object of the present invention is to provide a method for increasing a detection sensitivity of a radon monitor based on an electrostatic collection method through increasing a collection efficiency of positively charged ²¹⁸Po in an internal cell of the radon monitor based on the electrostatic collection method, and a device thereof, so as to overcome above deficiencies of conventional technologies.

Technical solutions of the present invention are describes as follows.

A first method for increasing a detection sensitivity of a radon monitor based on an electrostatic collection method, wherein the detection sensitivity of the radon monitor based on the electrostatic collection method is increased through increasing a collection efficiency of positively charged ²¹⁸Po in an internal cell of the radon monitor based on the electrostatic collection method, comprises steps of:

providing a single layer of metal mesh between a wall of the internal cell and a semiconductor detector, so as to increase an electric field intensity close to the wall of the internal cell, wherein a geometrical size of the metal mesh is similar with a geometrical size of the wall of the internal cell and the geometrical size of the metal mesh is smaller than the geometrical size of the wall of the internal cell;

isolating the wall of the internal cell from a surface of the semiconductor detector through the metal mesh;

connecting a ground wire of a high-voltage module to the surface of the semiconductor detector;

connecting high-voltage outputting wires of the high-voltage module respectively to the wall of the internal cell and the metal mesh, in such a manner that high voltages are respectively outputted between the wall of the internal cell and the metal mesh and between the metal mesh and the surface of the semiconductor detector;

adjusting the voltages between the wall of the internal cell and the metal mesh and between the metal mesh and the surface of semiconductor detector to appropriate values, so as to increase a collection efficiency of an electrostatic field to the positively charged ²¹⁸Po, wherein the electric field intensity close to the wall of the internal cell is increased through directly increasing a first voltage between the wall of the internal cell and the metal mesh.

The step of “adjusting the voltages between the wall of the internal cell and the metal mesh and between the metal mesh and the surface of the semiconductor detector” comprises steps of:

(A) switching on a pump on an outlet pipe of a first measuring device; and drawing air of a radon chamber into the internal cell through an inlet pipe, in such a manner that a radon concentration in the internal cell is identical to the radon concentration in the radon chamber;

(B) adjusting a second voltage between the metal mesh and the surface of the semiconductor detector; obtaining a first decay counting rate of the ²¹⁸Po which is measured by the semiconductor detector through a secondary meter, wherein the first decay counting rate increases with an increase of the second voltage; and stopping adjusting the second voltage between the metal mesh and the surface of the semiconductor detector when the first decay counting rate remains constant while the second voltage continues increasing; and

(C) adjusting the first voltage between the wall of the internal cell and the metal mesh; obtaining a second decay counting rate of the ²¹⁸Po which is measured by the semiconductor detector through the secondary meter, wherein the second decay counting rate increases with an increase of the first voltage; and stopping adjusting the first voltage between the wall of the internal cell and the metal mesh when the second decay counting rate remains constant while the first voltage continues increasing.

The first measuring device comprises the internal cell, the inlet pipe, the outlet pipe, the pump, the high-voltage module and the semiconductor detector, wherein:

the inlet pipe and the outlet pipe are respectively provided on the wall of the internal cell and intercommunicated with a cavity of the internal cell;

the pump is provided on the outlet pipe or the inlet pipe;

the semiconductor detector is provided on an insulating plate at a top part of the internal cell;

the metal mesh is provided in the cavity of the internal cell, wherein the geometrical size of the metal mesh is similar with the geometrical size of the wall of the internal cell, and the geometrical size of the metal mesh is smaller than the geometrical size of the wall of the internal cell; and the metal mesh is mounted on the insulating plate at the top part of the internal cell;

the wall of the internal cell is isolated from the surface of the semiconductor detector through the metal mesh;

the ground wire of the high-voltage module is connected to the surface of the semiconductor detector; and the high-voltage outputting wires of the high-voltage module are respectively connected to the wall of the internal cell and the metal mesh.

A mesh number of the metal mesh is 1-50.

The present invention has further technical solutions.

A second method for increasing a detection sensitivity of a radon monitor based on an electrostatic collection method comprises steps of:

providing at least two layers of metal meshes between a wall of an internal cell and a semiconductor detector, wherein geometrical sizes of the metal meshes are similar with a geometrical size of the wall of the internal cell; and each layer of the metal mesh is isolated from each other;

connecting a ground wire of a high-voltage module to a surface of the semiconductor detector; and

connecting high-voltage outputting wires of the high-voltage module respectively to the wall of the internal cell and each layer of the metal mesh, in such a manner that high voltages are respectively outputted between the wall of the internal cell and the metal mesh neighboring the wall of the internal cell, between each two neighbor layers of the metal meshes, and between the metal mesh neighboring the surface of the semiconductor detector and the surface of the semiconductor detector.

After adopting at least two layers of the metal meshes, the voltages are adjusted as follows:

(A) switching on a pump on an outlet pipe of a second measuring device; and drawing air of a radon chamber into the internal cell through an inlet pipe, in such a manner that a radon concentration in the internal cell is identical to the radon concentration in the radon chamber;

(B) adjusting a third voltage between the metal mesh neighboring the surface of the semiconductor detector and the surface of the semiconductor detector; obtaining a third decay counting rate of the ²¹⁸Po which is measured by the semiconductor detector through a secondary meter, wherein the third decay counting rate increases with an increase of the third voltage; and stopping adjusting the third voltage between the metal mesh neighboring the surface of the semiconductor detector and the surface of the semiconductor detector when the third decay counting rate remains constant while the third voltage continues increasing;

(C) adjusting a fourth voltage between each two neighbor metal meshes; obtaining a fourth decay counting rate of the ²¹⁸Po which is measured by the semiconductor detector through the secondary meter, wherein the fourth decay counting rate increases with an increase of the fourth voltage; and stopping adjusting the fourth voltage between the each two neighbor metal meshes when the fourth decay counting rate remains constant while the fourth voltage continues increasing; and

(D) adjusting a fifth voltage between the wall of the internal cell and the metal mesh neighboring the wall of the internal cell; obtaining a fifth decay counting rate of the ²¹⁸Po which is measured by the semiconductor detector through the secondary meter, wherein the fifth decay counting rate increases with an increase of the fifth voltage; and stopping adjusting the fifth voltage between the wall of the internal cell and the metal mesh neighboring the wall of the internal cell when the fifth decay counting rate remains constant while the fifth voltage continues increasing.

The second measuring device comprises the internal cell, the inlet pipe, the outlet pipe, the pump, the high-voltage module and the semiconductor detector, wherein:

the inlet pipe and the outlet pipe are respectively provided on the wall of the internal cell and intercommunicated with a cavity of the internal cell;

the pump is provided on the outlet pipe or the inlet pipe;

the semiconductor detector is provided on an insulating plate at a top part of the internal cell;

at least two layers of the metal meshes are provided in the cavity of the internal cell, wherein the geometrical sizes of the metal meshes are similar with the geometrical size of the wall of the internal cell; the metal meshes are respectively mounted on the insulating plate at the top part of the internal cell; and each layer of the metal mesh is isolated from each other;

the wall of the internal cell is isolated from the surface of the semiconductor detector through the metal meshes;

the ground wire of the high-voltage module is connected to the surface of the semiconductor detector; and the high-voltage outputting wires of the high-voltage module are respectively connected to the wall of the internal cell and each layer of the metal mesh.

A mesh number of the each metal mesh is 1-50.

Compared with the conventional technologies, the present invention has following benefits.

The method and the measuring device, provided by the present invention, are simple and have a high collection efficiency of the positively charged ²¹⁸Po in the internal cell of the radon monitor based on the electrostatic collection method. Because the collection efficiency of the positively charged ²¹⁸ Po in the internal cell of the radon monitor is increased, the detection sensitivity of the radon monitor is accordingly increased.

These and other objectives, features, and advantages of the present invention will become apparent from the following detailed description, the accompanying drawings, and the appended claims.

### BRIEF DESCRIPTION OF THE DRAWINGS

FIG. 1 is a structural sketch view of a first measuring device having a single layer of metal mesh according to a first preferred embodiment of the present invention, wherein an arrow shows a flow direction of airflow.

FIG. 2 is a structural sketch view of a second measuring device having two layers of the metal meshes according to a second preferred embodiment of the present invention, wherein the arrow shows the flow direction of the airflow.

FIG. 3 is a structural sketch view of a third measuring device having three layers of the metal meshes according to a third preferred embodiment of the present invention, wherein the arrow shows the flow direction of the airflow.

FIG. 4 is a structural sketch view of a conventional measuring device based on an electrostatic collection method according to prior arts, wherein the arrow shows the flow direction of the airflow.

### DETAILED DESCRIPTION OF THE PREFERRED EMBODIMENT

### First Preferred Embodiment

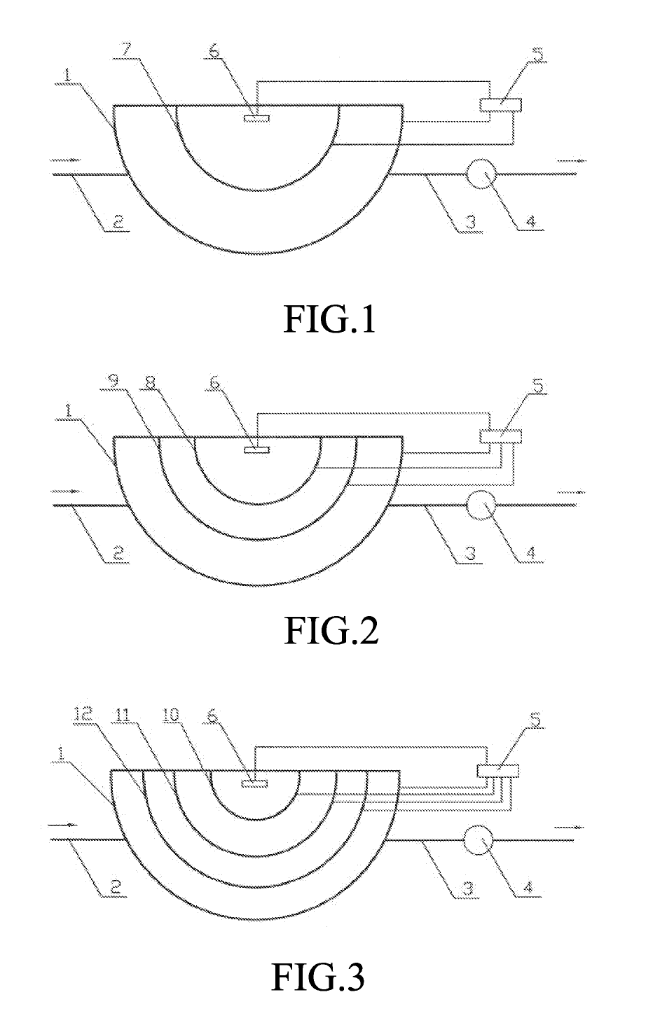

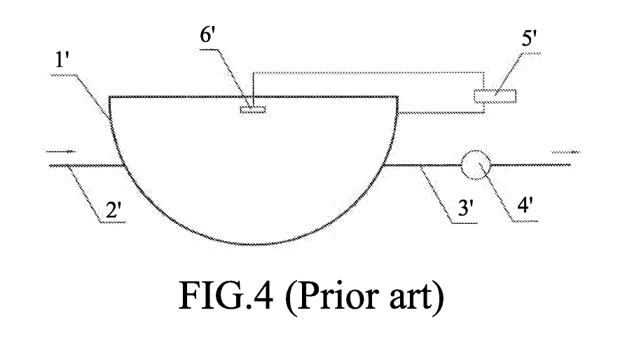

Referring to FIG. 1, according to a first preferred embodiment of the present invention, a first method for increasing a detection sensitivity of a radon monitor based on an electrostatic collection method is provided, which increases the detection sensitivity of the radon monitor based on the electrostatic collection method through increasing a collection efficiency of positively charged ²¹⁸Po in an internal cell of the radon monitor based on the electrostatic collection method. The first method comprises steps of:

providing a single layer of first metal mesh 7 between a wall of the internal cell 1 and a semiconductor detector 6, so as to increase an electric field intensity close to the wall of the internal cell 1, wherein a geometrical size of the first metal mesh 7 is similar with a geometrical size of the wall of the internal cell 1 and the geometrical size of the first metal mesh 7 is smaller than the geometrical size of the wall of the internal cell 1;

isolating the wall of the internal cell 1 from a surface of the semiconductor detector 6 through the first metal mesh 7;

connecting a ground wire of a high-voltage module 5 to the surface of the semiconductor detector 6;

connecting high-voltage outputting wires of the high-voltage module 5 respectively to the wall of the internal cell 1 and the first metal mesh 7, in such a manner that high voltages are respectively outputted between the wall of the internal cell 1 and the first metal mesh 7 and between the first metal mesh 7 and the surface of the semiconductor detector 6; and

adjusting the voltages between the wall of the internal cell 1 and the first metal mesh 7 and between the first metal mesh 7 and the surface of semiconductor detector 6 to appropriate values, so as to increase a collection efficiency of an electrostatic field to the positively charged ²¹⁸Po, wherein the electric field intensity close to the wall of the internal cell 1 is increased through directly increasing a first voltage between the wall of the internal cell 1 and the first metal mesh 7.

The step of “adjusting the voltages between the wall of the internal cell 1 and the first metal mesh 7 and between the first metal mesh 7 and the surface of semiconductor detector 6 to appropriate values” comprises steps of:

(A) switching on a pump 4 on an outlet pipe 3 of a first measuring device; and drawing air of a radon chamber into the internal cell 1 through an inlet pipe 2, in such a manner that a radon concentration in the internal cell 1 is identical to the radon concentration in the radon chamber;

(B) adjusting a second voltage between the first metal mesh 7 and the surface of the semiconductor detector 6; obtaining a first decay counting rate of the ²¹⁸Po which is measured by the semiconductor detector 6 through a secondary meter, wherein the first decay counting rate increases with an increase of the second voltage; and stopping adjusting the second voltage between the first metal mesh 7 and the surface of the semiconductor detector 6 when the first decay counting rate remains constant while the second voltage continues increasing; and

(C) adjusting the first voltage between the wall of the internal cell 1 and the first metal mesh 7; obtaining a second decay counting rate of the ²¹⁸Po which is measured by the semiconductor detector 6 through the secondary meter, wherein the second decay counting rate increases with an increase of the first voltage; and stopping adjusting the first voltage between the wall of the internal cell 1 and the first metal mesh 7 when the second decay counting rate remains constant while the first voltage continues increasing.

The first measuring device comprises the internal cell 1, the inlet pipe 2, the outlet pipe 3, the pump 4, the high-voltage module 5 and the semiconductor detector 6, wherein:

the inlet pipe 2 and the outlet pipe 3 are respectively provided on the wall of the internal cell 1 and intercommunicated with a cavity of the internal cell 1;

the pump 4 is provided on the outlet pipe 3 or the inlet pipe 2;

the semiconductor detector 6 is provided on an insulating plate at a top part of the internal cell 1;

the first metal mesh 7 is provided in the cavity of the internal cell 1, wherein the geometrical size of the first metal mesh 7 is similar with the geometrical size of the wall of the internal cell 1, and the geometrical size of the first metal mesh 7 is smaller than the geometrical size of the wall of the internal cell 1; and the first metal mesh 7 is mounted on the insulating plate at the top part of the internal cell 1;

the wall of the internal cell 1 is isolated from the surface of the semiconductor detector 6 through the first metal mesh 7;

the ground wire of the high-voltage module 5 is connected to the surface of the semiconductor detector 6; and the high-voltage outputting wires of the high-voltage module 5 are respectively connected to the wall of the internal cell 1 and the first metal mesh 7.

A mesh number of the first metal mesh 7 is 1-50.

### Second Preferred Embodiment

Referring to FIG. 2, according to a second preferred embodiment of the present invention, a second method for increasing a detection sensitivity of a radon monitor based on an electrostatic collection method is provided, which increases the detection sensitivity of the radon monitor based on the electrostatic collection method through increasing a collection efficiency of positively charged ²¹⁸Po in an internal cell of the radon monitor based on the electrostatic collection method. The second method comprises steps of:

providing two layers of metal meshes between a wall of the internal cell 1 and a semiconductor detector 5, so as to increase an electric intensity close to the wall of the internal cell 1, wherein the two layers of the metal meshes are respectively a second metal mesh 8 and a third metal mesh 9; geometrical sizes of the two metal meshes, 8 and 9, are similar with a geometrical size of the wall of the internal cell 1; the geometrical size of the second metal mesh 8 is smaller than the geometrical size of the third metal mesh 9; and, the geometrical size of the third metal mesh 9 is smaller than the geometrical size of the wall of the internal cell 1;

isolating the wall of the internal cell 1 from a surface of the semiconductor detector 6 through the metal meshes;

connecting a ground wire of a high-voltage module 5 to the surface of the semiconductor detector 5;

connecting high-voltage outputting wires of the high-voltage module 5 respectively to the wall of the internal cell 1, the second metal mesh 8 and the third metal mesh 9, in such a manner that high voltages are respectively outputted between the wall of the internal cell 1 and the third metal mesh 9, between the third metal mesh 9 and the second metal mesh 8, and between the second metal mesh 8 and the surface of the semiconductor detector 6; and

adjusting the voltages between the wall of the internal cell 1 and the third metal mesh 9, between the third metal mesh 9 and the second metal mesh 8, and between the second metal mesh 8 and the surface of semiconductor detector 6 to appropriate values, so as to increase a collection efficiency of an electrostatic field to the positively charged ²¹⁸Po, wherein the electric field intensity close to the wall of the internal cell 1 is increased through directly increasing the voltages between the wall of the internal cell 1 and the third metal mesh 9, between the third metal mesh 9 and the second metal mesh 8, and between the second metal mesh 8 and the surface of the semiconductor detector 6.

The step of “adjusting the voltages” comprises steps of:

(A) switching on a pump 4 on an outlet pipe 3 of a second measuring device; and drawing air of a radon chamber into the internal cell 1 through an inlet pipe 2, in such a manner that a radon concentration in the internal cell 1 is identical to the radon concentration in the radon chamber;

(B) adjusting a third voltage between the second metal mesh 8 and the surface of the semiconductor detector 6; obtaining a third decay counting rate of the ²¹⁸Po which is measured by the semiconductor detector 6 through a secondary meter, wherein the third decay counting rate increases with an increase of the second voltage; and stopping adjusting the second voltage between the second metal mesh 8 and the surface of the semiconductor detector 6 when the third decay counting rate remains constant while the third voltage continues increasing;

(C) adjusting a fourth voltage between the third metal mesh 9 and the second metal mesh 8; obtaining a fourth decay counting rate of the ²¹⁸Po which is measured by the semiconductor detector 6 through the secondary meter, wherein the fourth decay counting rate increases with an increase of the fourth voltage; and stopping adjusting the fourth voltage between the third metal mesh 9 and the second metal mesh 8 when the fourth decay counting rate remains constant while the fourth voltage continues increasing; and

(D) adjusting a fifth voltage between the wall of the internal cell 1 and the third metal mesh 9; obtaining a fifth decay counting rate of the ²¹⁸Po which is measured by the semiconductor detector 6 through the secondary meter, wherein the fifth decay counting rate increases with an increase of the fifth voltage; and stopping adjusting the fifth voltage between the wall of the internal cell 1 and the third metal mesh 9 when the fifth decay counting rate remains constant while the fifth voltage continues increasing.

The second measuring device comprises the internal cell 1, the inlet pipe 2, the outlet pipe 3, the pump 4, the high-voltage module 5 and the semiconductor detector 6, wherein:

the inlet pipe 2 and the outlet pipe 3 are respectively provided on the wall of the internal cell 1 and intercommunicated with a cavity of the internal cell 1;

the pump 4 is provided on the outlet pipe 3 or the inlet pipe 2;

the semiconductor detector 6 is provided on an insulating plate at a top part of the internal cell 1;

the two metal meshes are provided in the cavity of the internal cell 1, wherein the geometrical sizes of the metal meshes are similar with the geometrical size of the wall of the internal cell 1; the two metal meshes are respectively the second metal mesh 8 and the third metal mesh 9; the geometrical size of the third metal mesh 9 is smaller than the geometrical size of the wall of the internal cell 1; the geometrical size of the second metal mesh 8 is smaller than the geometrical size of the third metal mesh 9; and the two metal meshes are respectively mounted on the insulating plate at the top part of the internal cell 1;

the wall of the internal cell 1 is isolated from the surface of the semiconductor detector 6 through the metal meshes;

the ground wire of the high-voltage module 5 is connected to the surface of the semiconductor detector 6; and the high-voltage outputting wires of the high-voltage module 5 are respectively connected to the wall of the internal cell 1, the second metal mesh 8 and the third metal mesh 9.

A mesh number of the each metal mesh is 1-50.

### Third Preferred Embodiment

Referring to FIG. 3, according to a third preferred embodiment of the present invention, a third method for increasing a detection sensitivity of a radon monitor based on an electrostatic collection method is provided, which increases the detection sensitivity of the radon monitor based on the electrostatic collection method through increasing a collection efficiency of positively charged ²¹⁸Po in an internal cell of the radon monitor based on the electrostatic collection method. The third method comprises steps of:

providing three layers of metal meshes between a wall of the internal cell 1 and a semiconductor detector 6, so as to increase an electric field intensity close to the wall of the internal cell 1, wherein geometrical sizes of the metal meshes are similar with a geometrical size of the wall of the internal cell 1; the three layers of the metal meshes are respectively a fourth metal mesh 10, a fifth metal mesh 11 and a sixth metal mesh 12; a geometrical size of the sixth metal mesh 12 is smaller than the geometrical size of the wall of the internal cell 1; a geometrical size of the fifth metal mesh 11 is smaller than the geometrical size of the sixth metal mesh 12; and a geometrical size of the fourth metal mesh 10 is smaller than the geometrical size of the fifth metal mesh 11;

isolating the wall of the internal cell 1 from a surface of the semiconductor detector 6 through the metal meshes;

connecting a ground wire of a high-voltage module 5 to the surface of the semiconductor detector 5;

connecting high-voltage outputting wires of the high-voltage module 5 respectively to the wall of the internal cell 1, the fourth metal mesh 10, the fifth metal mesh 11 and the sixth metal mesh 12, in such a manner that high voltages are respectively outputted between the wall of the internal cell 1 and the sixth metal mesh 12, between the sixth metal mesh 12 and the fifth metal mesh 11, between the fifth metal mesh 11 and the fourth metal mesh 10, and between the fourth metal mesh 10 and the surface of the semiconductor detector 6; and

adjusting the voltages between the wall of the internal cell 1 and the sixth metal mesh 12, between the sixth metal mesh 12 and the fifth metal mesh 11, between the fifth metal mesh 11 and the fourth metal mesh 10, and between the fourth metal mesh 10 and the surface of the semiconductor detector 6 to appropriate values, so as to increase a collection efficiency of an electrostatic field to the positively charged ²¹⁸Po, wherein the electric field intensity close to the wall of the internal cell 1 is increased through directly increasing the voltages between the wall of the internal cell 1 and the sixth metal mesh 12, between the sixth metal mesh 12 and the fifth metal mesh 11, between the fifth metal mesh 11 and the fourth metal mesh 10, and between the fourth metal mesh 10 and the surface of the semiconductor detector 6.

The step of “adjusting the voltages” comprises steps of:

(A) switching on a pump 4 on an outlet pipe 3 of a third measuring device; and drawing air of a radon chamber into the internal cell 1 through an inlet pipe 2, in such a manner that a radon concentration in the internal cell 1 is identical to the radon concentration in the radon chamber;

(B) adjusting a sixth voltage between the fourth metal mesh 10 and the surface of the semiconductor detector 6; obtaining a sixth decay counting rate of the ²¹⁸Po which is measured by the semiconductor detector 6 through a secondary meter, wherein the sixth decay counting rate increases with an increase of the sixth voltage; and stopping adjusting the sixth voltage between the fourth metal mesh 10 and the surface of the semiconductor detector 6 when the sixth decay counting rate remains constant while the sixth voltage continues increasing;

(C) adjusting a seventh voltage between the fifth metal mesh 11 and the fourth metal mesh 10; obtaining a seventh decay counting rate of the ²¹⁸Po which is measured by the semiconductor detector 6 through the secondary meter, wherein the seventh decay counting rate increases with an increase of the seventh voltage; and stopping adjusting the seventh voltage between the fifth metal mesh 11 and the fourth metal mesh 10 when the seventh decay counting rate remains constant while the seventh voltage continues increasing;

(D) adjusting an eighth voltage between the sixth metal mesh 12 and the fifth metal mesh 11; obtaining an eighth decay counting rate of the ²¹⁸Po which is measured by the semiconductor detector 6 through the secondary meter, wherein the eighth decay counting rate increases with an increase of the eighth voltage; and stopping adjusting the eighth voltage between the sixth metal mesh 12 and the fifth metal mesh 11 when the eighth decay counting rate remains constant while the eighth voltage continues increasing; and

(E) adjusting a ninth voltage between the wall of the internal cell 1 and the sixth metal mesh 12; obtaining a ninth decay counting rate of the ²¹⁸Po which is measured by the semiconductor detector 6 through the secondary meter, wherein the ninth decay counting rate increases with an increase of the ninth voltage; and stopping adjusting the ninth voltage between the wall of the internal cell 1 and the sixth metal mesh 12 when the ninth decay counting rate remains constant while the ninth voltage continues increasing.

The third measuring device comprises the internal cell 1, the inlet pipe 2, the outlet pipe 3, the pump 4, the high-voltage module 5 and the semiconductor detector 6, wherein:

the inlet pipe 2 and the outlet pipe 3 are respectively provided on the wall of the internal cell 1 and intercommunicated with a cavity of the internal cell 1;

the pump 4 is provided on the outlet pipe 3 or the inlet pipe 2;

the semiconductor detector 6 is provided on an insulating plate at a top part of the internal cell 1;

the three metal meshes are provided in the cavity of the internal cell 1, wherein the geometrical sizes of the metal meshes are similar with the geometrical size of the wall of the internal cell 1; the three metal meshes are respectively the fourth metal mesh 10, the fifth metal mesh 11 and the sixth metal mesh 12; the geometrical size of the sixth metal mesh 12 is smaller than the geometrical size of the wall of the internal cell 1; the geometrical size of the fifth metal mesh 11 is smaller than the geometrical size of the sixth metal mesh 12; the geometrical size of the fourth metal mesh 10 is smaller than the geometrical size of the fifth metal mesh 11; and the metal meshes are respectively mounted on the insulating plate at the top part of the internal cell 1;

the wall of the internal cell 1 is isolated from the surface of the semiconductor detector 6 through the metal meshes;

the ground wire of the high-voltage module 5 is connected to the surface of the semiconductor detector 6; and the high-voltage outputting wires of the high-voltage module 5 are respectively connected to the wall of the internal cell 1, the fourth metal mesh 10, the fifth metal mesh 11 and the sixth metal mesh 12.

A mesh number of the each metal mesh is 1-50.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1. A method for increasing a detection sensitivity of a radon monitor based on an electrostatic collection method, wherein the detection sensitivity of the radon monitor based on the electrostatic collection method is increased through increasing a collection efficiency of positively charged ²¹⁸ Po in an internal cell of the radon monitor based on the electrostatic collection method, comprising steps of:
providing a single layer of metal mesh between a wall of the internal cell and a semiconductor detector, so as to increase an electric field intensity close to the wall of the internal cell, wherein a geometrical size of the metal mesh is similar with a geometrical size of the wall of the internal cell and the geometrical size of the metal mesh is smaller than the geometrical size of the wall of the internal cell;
isolating the wall of the internal cell from a surface of the semiconductor detector through the metal mesh;
connecting a ground wire of a high-voltage module to the surface of the semiconductor detector;
connecting high-voltage outputting wires of the high-voltage module respectively to the wall of the internal cell and the metal mesh, in such a manner that high voltages are respectively outputted between the wall of the internal cell and the metal mesh and between the metal mesh and the surface of the semiconductor detector; and
adjusting the voltages between the wall of the internal cell and the metal mesh and between the metal mesh and the surface of semiconductor detector to appropriate values, so as to increase a collection efficiency of an electrostatic field to the positively charged ²¹⁸Po, wherein the electric field intensity close to the wall of the internal cell is increased through directly increasing a first voltage between the wall of the internal cell and the metal mesh.

2. The method for increasing the detection sensitivity of the radon monitor based on the electrostatic collection method, as recited in claim 1, wherein the step of “adjusting the voltages between the wall of the internal cell and the metal mesh and between the metal mesh and the surface of semiconductor detector to appropriate values” comprises steps of:
(A) switching on a pump on an outlet pipe of a measuring device; and drawing air of a radon chamber into the internal cell through an inlet pipe, in such a manner that a radon concentration in the internal cell is identical to the radon concentration in the radon chamber;
(B) adjusting a second voltage between the metal mesh and the surface of the semiconductor detector; obtaining a first decay counting rate of the ²¹⁸Po which is measured by the semiconductor detector through a secondary meter, wherein the first decay counting rate increases with an increase of the second voltage; and stopping adjusting the second voltage between the metal mesh and the surface of the semiconductor detector when the first decay counting rate remains constant while the second voltage continues increasing; and
(C) adjusting the first voltage between the wall of the internal cell and the metal mesh; obtaining a second decay counting rate of the ²¹⁸Po which is measured by the semiconductor detector through the secondary meter, wherein the second decay counting rate increases with an increase of the first voltage; and stopping adjusting the first voltage between the wall of the internal cell and the metal mesh when the second decay counting rate remains constant while the first voltage continues increasing.

3. The method for increasing the detection sensitivity of the radon monitor based on the electrostatic collection method, as recited in claim 2, wherein the measuring device comprises the internal cell, the inlet pipe, the outlet pipe, the pump, the high-voltage module and the semiconductor detector, wherein:
the inlet pipe and the outlet pipe are respectively provided on the wall of the internal cell and intercommunicated with a cavity of the internal cell;
the pump is provided on the outlet pipe or the inlet pipe;
the semiconductor detector is provided on an insulating plate at a top part of the internal cell;
the metal mesh is provided in the cavity of the internal cell, wherein the geometrical size of the metal mesh is similar with the geometrical size of the wall of the internal cell, and the geometrical size of the metal mesh is smaller than the geometrical size of the wall of the internal cell; and the metal mesh is mounted on the insulating plate at the top part of the internal cell;
the wall of the internal cell is isolated from the surface of the semiconductor detector through the metal mesh;
the ground wire of the high-voltage module is connected to the surface of the semiconductor detector; and the high-voltage outputting wires of the high-voltage module are respectively connected to the wall of the internal cell and the metal mesh.

4. The method for increasing the detection sensitivity of the radon monitor based on the electrostatic collection method, as recited in claim 3, wherein a mesh number of the metal mesh is 1-50.

5. A method for increasing a detection sensitivity of a radon monitor based on an electrostatic collection method, wherein the detection sensitivity of the radon monitor based on the electrostatic collection method is increased through increasing a collection efficiency of positively charged ²¹⁸ Po in an internal cell of the radon monitor based on the electrostatic collection method, comprising steps of:
providing at least two layers of metal meshes between a wall of the internal cell and a semiconductor detector, wherein geometrical sizes of the metal meshes are similar with a geometrical size of the wall of the internal cell; and each layer of the metal mesh is isolated from each other;
connecting a ground wire of a high-voltage module to a surface of the semiconductor detector; and
connecting high-voltage outputting wires of the high-voltage module respectively to the wall of the internal cell and each layer of the metal mesh, in such a manner that high voltages are respectively outputted between the wall of the internal cell and the metal mesh neighboring the wall of the internal cell, between each two neighbor layers of the metal meshes, and between the metal mesh neighboring the surface of the semiconductor detector and the surface of the semiconductor detector; and
adjusting the voltages between the wall of the internal cell and the metal mesh neighboring the wall of the internal cell, between each two neighbor layers of the metal meshes, and between the metal mesh neighboring the surface of the semiconductor detector and the surface of the semiconductor detector to appropriate values, so as to increase a collection efficiency of an electrostatic field to the positively charged ²¹⁸Po, wherein an electric field intensity close to the wall of the internal cell is increased through directly increasing the voltages between the wall of the internal cell and the metal mesh neighboring the wall of the internal cell, between each two neighbor layers of the metal meshes, and between the metal mesh neighboring the surface of the semiconductor detector and the surface of the semiconductor detector.

6. The method for increasing the detection sensitivity of the radon monitor based on the electrostatic collection method, as recited in claim 5, wherein the step of “adjusting the voltages” comprises steps of:
(A) switching on a pump on an outlet pipe of a measuring device; and drawing air of a radon chamber into the internal cell through an inlet pipe, in such a manner that a radon concentration in the internal cell is identical to the radon concentration in the radon chamber;
(B) adjusting a third voltage between the metal mesh neighboring the surface of the semiconductor detector and the surface of the semiconductor detector; obtaining a third decay counting rate of the ²¹⁸Po which is measured by the semiconductor detector through a secondary meter, wherein the third decay counting rate increases with an increase of the third voltage; and stopping adjusting the third voltage between the metal mesh neighboring the surface of the semiconductor detector and the surface of the semiconductor detector when the third decay counting rate remains constant while the third voltage continues increasing;
(C) adjusting a fourth voltage between each two neighbor metal meshes; obtaining a fourth decay counting rate of the ²¹⁸Po which is measured by the semiconductor detector through the secondary meter, wherein the fourth decay counting rate increases with an increase of the fourth voltage; and stopping adjusting the fourth voltage between the each two neighbor metal meshes when the fourth counting rate remains constant while the fourth voltage continues increasing; and
(D) adjusting a fifth voltage between the wall of the internal cell and the metal mesh neighboring the wall of the internal cell; obtaining a fifth decay counting rate of the ²¹⁸Po which is measured by the semiconductor detector through the secondary meter, wherein the fifth decay counting rate increases with an increase of the fifth voltage; and stopping adjusting the fifth voltage between the wall of the internal cell and the metal mesh neighboring the wall of the internal cell when the fifth decay counting rate remains constant while the fifth voltage continues increasing.

7. The method for increasing the detection sensitivity of the radon monitor based on the electrostatic collection method, as recited in claim 6, wherein:
the measuring device comprises the internal cell, the inlet pipe, the outlet pipe, the pump, the high-voltage module and the semiconductor detector;
the inlet pipe and the outlet pipe are respectively provided on the wall of the internal cell and intercommunicated with a cavity of the internal cell;
the pump is provided on the outlet pipe or the inlet pipe;
the semiconductor detector is provided on an insulating plate at a top part of the internal cell;
at least two layers of the metal meshes are provided in the cavity of the internal cell, wherein the geometrical sizes of the metal meshes are similar with the geometrical size of the wall of the internal cell; the metal meshes are respectively mounted on the insulating plate at the top part of the internal cell; and each layer of the metal mesh is isolated from each other;
the wall of the internal cell is isolated from the surface of the semiconductor detector through the metal meshes;
the ground wire of the high-voltage module is connected to the surface of the semiconductor detector; and the high-voltage outputting wires of the high-voltage module are respectively connected to the wall of the internal cell and each layer of the metal mesh.

8. The method for increasing the detection sensitivity of the radon monitor based on the electrostatic collection method, as recited in claim 7, wherein: a mesh number of the each metal mesh is 1-50.
